(19) United States
(12) Patent Application Publication
(10) Pub. No.: US 2019/0051075 A1
(43) Pub. Date: Feb. 14, 2019

(54) ELECTRONIC LOCK AUTHENTICATION METHOD AND SYSTEM

(71) Applicant: Schlage Lock Company LLC, Carmel, IN (US)

(72) Inventors: John R. Ahearn, Pasadena, CA (US); Joseph W. Baumgarte, Carmel, IN (US); Gabriel D. Focke, Sunman, IN (US); Michael S. Henney, Indianapolis, IN (US)

(21) Appl. No.: 16/161,506

(22) Filed: Oct. 16, 2018

Related U.S. Application Data
(63) Continuation of application No. 15/257,113, filed on Sep. 6, 2016, now Pat. No. 10,102,699.
Application No. 15/257,113 is a continuation of application No. 13/968,671, filed on Aug. 16, 2013, now Pat. No. 9,437,062.
(60) Provisional application No. 61/684,114, filed on Aug. 16, 2012.

(51) Int. Cl. G07C 9/00

(52) U.S. Cl. CPC G07C 9/00309; G07C 9/00571; G07C 2009/00412; G07C 2009/00769; G07C 9/00174

(57) ABSTRACT

An electronic lock authentication system and associated method including an electronic lock and a cellular phone in communication with a network and in wireless communication with the electronic lock. The electronic lock has a lock identification and is configured to transmit the lock identification wirelessly to the cellular phone. The cellular phone has a phone identification and is configured to transmit the lock identification and the phone identification to the network. The network is configured to make a decision in real time whether the cellular phone is permitted access to the electronic lock based on the lock identification and the phone identification, and is further configured to transmit a grant/deny message to the cellular phone based on the decision, and the cellular phone is configured to transmit the grant/deny message to the electronic lock.

### CROSS-REFERENCE TO RELATED APPLICATIONS

The present application claims the benefit of U.S. Provisional Patent Application No. 61/684,114 filed on Aug. 16, 2012, the contents of which are incorporated herein by reference in their entirety.

### TECHNICAL FIELD

The technical field generally relates to an electronic lock authentication method and system, and more particularly, but not exclusively, relates to electronic lock authentication via a network and a cellular telephone.

### BACKGROUND

Authentication systems may include an access control panel (ACP) which makes an access control decision. The authentication may be between a controller and the ACP. Some existing systems have various shortcomings relative to certain applications. Accordingly, there remains a need for further contributions in this area of technology.

### SUMMARY

One embodiment of the present invention is a unique electronic lock authentication system. Other embodiments include apparatuses, systems, devices, hardware, methods, and combinations for electronic lock authentication. Further embodiments, forms, features, aspects, benefits, and advantages of the present application shall become apparent from the description and figures provided herewith.

### BRIEF DESCRIPTION OF THE FIGURES

FIG. 1 is a diagram illustrating an electronic lock authentication system and method.

FIG. 2 is a diagram illustrating an electronic lock authentication system and method that makes use of credential information.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation on the scope of the invention is hereby intended. Any alterations and further modifications in the described embodiments, and any further applications of the principles of the invention as described herein are contemplated as would normally occur to one skilled in the art to which the invention relates.

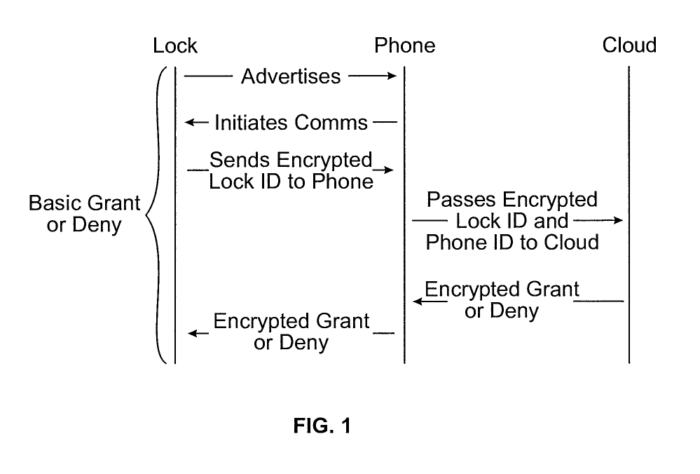

With reference to FIG. 1, an electronic lock authentication system and method in one embodiment includes communication between a lock, a cellular telephone, and a network. The cellular telephone may be a smartphone, for example, and the network may be a network cloud, for example.

The lock advertises its presence, for example, while in a low power sleep state. The lock may perform such advertising, for example, once every ‘x’ amount of time. The cellular telephone scans for devices in its range, which may occur, for example, when the cellular telephone is in a low power scan mode. When a lock is in range, the cellular telephone initiates communication with the lock. The lock, in turn, transmits its encrypted Lock ID to the cellular telephone. The cellular telephone then transmits the encrypted Lock ID and its Phone ID to the network cloud.

The network cloud makes a decision, which in one embodiment may be in real time, as to whether the cellular telephone is permitted access to the door based on the Lock ID and the Phone ID.

The network cloud then transmits an encrypted grant or deny message to the cellular telephone, which in turn transmits the encrypted grant or deny message to the lock.

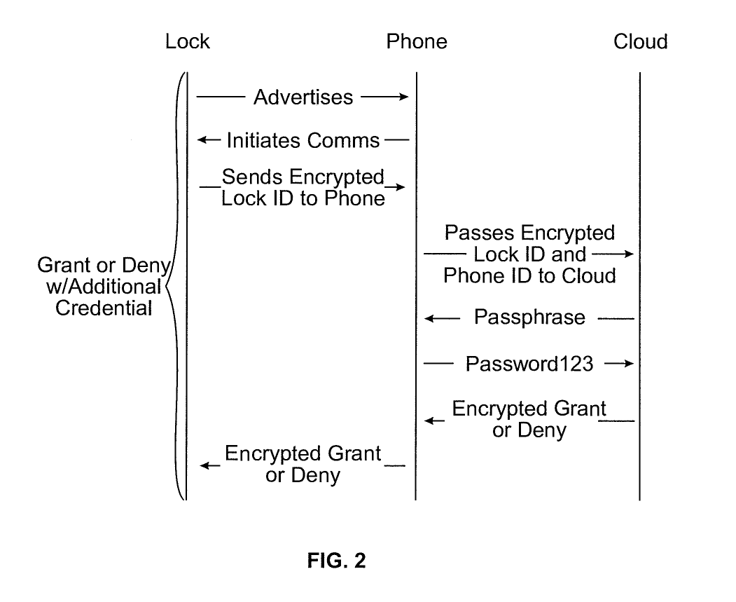

FIG. 2 illustrates an electronic lock authentication system and method, which, as in the FIG. 1 embodiment, includes communication between a lock, a cellular telephone, and a network. In the FIG. 2 embodiment, the cellular telephone transmits additional credential information.

The lock advertises its presence, for example, while in a low power sleep state. The lock may perform such advertising, for example, once every ‘x’ amount of time. The cellular telephone scans for devices in its range, which may occur, for example, when the cellular telephone is in a low power scan mode. When a lock is in range, the cellular telephone initiates communication with the lock. The lock, in turn, transmits its encrypted Lock ID to the cellular telephone. The cellular telephone then transmits the encrypted Lock ID and its Phone ID to the network cloud.

The network cloud makes a decision, which in one embodiment may be in real time, as to whether the cellular telephone is permitted access to the door based on the Lock ID and the Phone ID.

In the FIG. 2 embodiment, the network cloud requests additional credential information from the cellular telephone, which may be provided, for example, by the user of the cellular telephone. The network cloud transmits a message to the cellular telephone indicating additional credential information is required. In one embodiment, the user of the cellular telephone inputs the required additional credential information into the cellular telephone. This input can be different credential types, for example, a pin code, a passphrase, a gesture with the phone, and facial or voice recognition to the network cloud via the cellular telephone.

The network cloud then makes a decision, which in one embodiment may be in real time, as to whether the additional credential information is correct.

The network cloud then transmits an encrypted grant or deny message to the cellular telephone, which in turn transmits the encrypted grant or deny message to the lock.

In one embodiment, the system architecture allows the major communication pipeline to be between the cellular telephone and the cloud, which in turn allows the electronics resident on the door to be a much simpler and smaller form factor design.

In one embodiment, the system architecture provides ways to provide additional credential information to the network cloud which may take the form of for example a “phone+additional credential information” application.

In one embodiment, real time access control verification allows for no wires to be needed in an installation. Further, the electronic lock may be battery powered and have the ability to “go online” through the cellular telephone's internet connection. In one embodiment, the cellular telephone would provide the communication path between the lock and the network cloud, allowing a real time access control decision, without a hardwired connection for the lock.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1.-17. (canceled)

18. A method, comprising:
scanning, by a cellular phone, for an advertisement indicating the presence of an electronic lock;
based upon the scanning, determining whether the cellular phone is within a specified range of the electronic lock;
in response to determining that the cellular phone is within the specified range of the electronic lock, establishing a wireless communication connection between the electronic lock and the cellular phone;
receiving, by the cellular phone via the wireless communication connection, a lock identification identifying the electronic lock;
transmitting, from the cellular phone to a network, the lock identification;
transmitting, from the cellular phone to the network, a cellular phone identification identifying the cellular phone;
receiving, by the cellular phone, a grant/deny message from the network, the grant/deny message indicating whether the cellular phone is permitted access to the electronic lock; and
transmitting the grant/deny message from the cellular phone to the electronic lock.

19. The method of claim 18, further comprising prompting, by the cellular phone, a user to input additional credential information into the cellular phone; and
transmitting, from the cellular phone to the network, the inputted additional credential information.

20. The method of claim 19, further comprising receiving, by the cellular phone, a request from the network for the additional credential information; and
wherein the prompting is performed in response to receiving the request.

21. The method of claim 19, wherein the additional credential information includes data relating to at least one of a pin code, a passphrase, a gesture with the cellular phone, facial recognition, and voice recognition.

22. The method of claim 19, wherein the network determines whether the cellular phone is permitted access to the electronic lock based on the lock identification, the cellular phone identification, and the additional credential information.

23. The method of claim 18, further comprising issuing, by the electronic lock, the advertisement.

24. The method of claim 23, wherein the issuing of the advertisement is performed by the electronic lock while the electronic lock is in a low-power sleep mode.

25. The method of claim 18, further comprising encrypting the lock identification, and wherein transmitting the lock identification comprises transmitting the encrypted lock identification.

26. The method of claim 18, wherein the network comprises a network cloud.

27. The method of claim 18, wherein establishing the wireless communication connection comprises the cellular phone initiating the wireless communication connection.

28. The method of claim 27, further comprising transmitting, by the electronic lock, the lock identification in response to the cellular phone initiating the wireless communication connection.

29. The method of claim 18, wherein the scanning is performed while the cellular phone is in a low-power scan mode.

30. A system, comprising:
an electronic lock transmitting an advertisement indicating a presence of the electronic lock;
a cellular phone in wireless communication with a network;
wherein the cellular phone is configured to initiate wireless communication with the electronic lock based upon receiving the advertisement;
wherein the electronic lock is configured to transmit, to the cellular phone and in response to the cellular phone initiating the wireless communication, a lock identification; and
wherein the cellular phone is configured to:
transmit to the network the lock identification;
transmit to the network a cellular phone identification;
receive from the network a grant/deny message from the network, the grant/deny message indicating whether the cellular phone is permitted access to the electronic lock; and
in response to receiving the grant/deny message from the network, transmit to the electronic lock the grant/deny message.

31. The system of claim 30, wherein the cellular phone is further configured to:
prompt a user to input additional credential information into the cellular phone; and
transmit to the network the inputted additional credential information.

32. The system of claim 31, wherein the cellular phone is configured to prompt the user to input the additional credential information into the cellular phone in response to receiving from the network a request for the additional credential information.

33. The system of claim 30, wherein the electronic lock is further configured to unlock in response to the grant/deny message indicating that the cellular phone is permitted access to the electronic lock.

34. The system of claim 30, wherein the electronic lock has a low-power sleep mode and is configured to issue the advertisement while in the low-power sleep mode.

35. The system of claim 30, wherein the cellular phone is further configured to scan for the advertisement while in a low-power scan mode.

36. The system of claim 30, wherein the cellular phone is configured to initiate wireless communication with the electronic lock based upon receiving the advertisement and in response to determining that the cellular phone is within a predetermined range of the electronic lock.

37. The system of claim 30, wherein the lock is configured to transmit the lock identification as an encrypted lock identification.
